(19) United States
(12) Patent Application Publication
(10) Pub. No.: US 2015/0363383 A1
(43) Pub. Date: Dec. 17, 2015

(54) INPUT SUPPORT SYSTEM, INPUT SUPPORT METHOD AND INPUT SUPPORT PROGRAM

(71) Applicant: NEC SOLUTION INNOVATORS, LTD., Koto-ku, Tokyo (JP)

(72) Inventors: Yuzuru OKAJIMA, Tokyo (JP); Kosuke YAMAMOTO, Tokyo (JP)

(73) Assignee: NEC Solution Innovators, Ltd., Koto-ku, Tokyo (JP)

(21) Appl. No.: 14/761,234

(22) PCT Filed: Dec. 27, 2013
(86) PCT No.: PCT/JP2013/007672

§ 371 Date: Jul. 15, 2015

(30) Foreign Application Priority Data
Jan. 22, 2013 (JP) 2013-009573

(51) Int. Cl. G06F 17/27

(52) U.S. Cl. CPC G06F 17/276; G06F 17/2735

(57) ABSTRACT

A candidate character string storage unit 81 stores candidate character strings recommended for an input character string. A recommended character string decision unit 82 decides recommended character strings for the input character string. A character string set decision unit 83 decides a set of candidate character strings out of the candidate character strings stored in the candidate character string storage unit 81 based on the character string set identification information, which is information by which the set of candidate character strings is identifiable. The character string set decision unit 83 decides the set of candidate character strings based on the character string set identification information determined according to an input place of the character string. The recommended character string decision unit 82 decides the recommended character strings for the input character string by using the decided set of candidate character strings.

### TECHNICAL FIELD

The present invention relates to an input support system, an input support method, and an input support program for supporting input to an input box by a user.

### BACKGROUND ART

There have been known various methods of recommending appropriate character strings for characters input by a user.

For example, there is a method of performing predictive conversion by using character strings input by a user in the past. In this method, a history input by the user in the past is retained and thereafter the character strings input by the user in the past are recommended when the user starts input anew.

There is also known a suggest function using character strings input in the past by a large number of users. For example, the search site, which receives a keyword and returns a search result, retains a history of the character strings input in the past for search and thereafter the search site recommends character strings out of the character strings input in the past by an unspecified large number of users when an arbitrary user starts input anew.

Moreover, Patent Literature (PTL) 1 discloses a character input device which selects predictive conversion candidates according to the input state. The character input device disclosed in PTL 1 is provided with plural types of predictive conversion dictionaries according to the input state. When a user sets the input state, the character input device displays predictive conversion candidates on the basis of a predictive conversion dictionary corresponding to the set input state.

### CITATION LIST

### Patent Literature(s)

PTL 1: Japanese Patent Application Laid-Open No. 2009-15781

### SUMMARY OF INVENTION

### Technical Problem

The search engine that implements the suggest function retains the past histories input in the search engine and therefore is able to recommend character strings often input to the search engine. This type of search engine, however, has problems that it is difficult to recommend character strings not input in the past and that it is difficult to recommend appropriate character strings unless a large number of users exist.

Meanwhile, the search engine is able to provide an input environment customized for a user by using character strings input by the user in the past. The character strings input by the user, however, are various according to a search site, an input screen, or an input box where the user inputs the character strings. Therefore, it is hard to say that the search engine is able to recommend appropriate character strings according to an input place. Therefore, it is preferable for the search engine to be able to recommend appropriate input candidates according to the input place.

Furthermore, in the character input device disclosed in PTL 1, characters are input to the same input area and a user explicitly selects a dictionary according to the input state. Specifically, the user needs to select the dictionary for use in conversion of a character string before inputting the character string to the input area, which problematically complicates the input operation.

Therefore, an object of the present invention is to provide an input support system, an input support method, and an input support program capable of recommending appropriate input candidates according to an input place without performing a complicated operation.

### Solution to Problem

According to an aspect of the present invention, there is provided an input support system including: a candidate character string storage unit which stores candidate character strings recommended for an input character string; a recommended character string decision unit which decides the recommended character strings for the input character string; and a character string set decision unit which decides a set of candidate character strings out of the candidate character strings stored in the candidate character string storage unit based on character string set identification information which is information by which the set of candidate character strings is identifiable, wherein: the character string set decision unit decides the set of candidate character strings based on the character string set identification information determined according to an input place of the character string; and the recommended character string decision unit decides the recommended character strings for the input character string by using the decided set of candidate character strings.

According to another aspect of the present invention, there is provided an input support method including the steps of: deciding a set of candidate character strings out of candidate character strings stored in a candidate character string storage unit which stores candidate character strings based on character string set identification information which is information by which a set of candidate character strings recommended for an input character string is identifiable; and deciding the recommended character strings for the input character string by using the decided set of candidate character strings, wherein the set of candidate character strings is decided based on the character string set identification information determined according to an input place of the character string.

According to still another aspect of the present invention, there is provided an input support program causing a computer to perform: character string set decision processing of deciding a set of candidate character strings out of candidate character strings stored in a candidate character string storage unit which stores candidate character strings based on character string set identification information which is information by which a set of candidate character strings recommended for an input character string is identifiable; and recommended character string decision processing of deciding the recommended character strings for the input character string by using the decided set of candidate character strings, wherein the computer is caused to decide the set of candidate character strings based on the character string set identification information determined according to an input place of the character string in the character string set decision processing.

### Advantageous Effects of Invention

According to the present invention, appropriate input candidates are able to be recommended according to an input place without performing a complicated operation.

### BRIEF DESCRIPTION OF DRAWINGS

FIG. 1 It depicts an explanatory diagram illustrating a configuration example of a first exemplary embodiment of an input support system according to the present invention.

FIG. 2 It depicts an explanatory diagram illustrating an example of sets of candidate character strings stored in a candidate character string storage unit.

FIG. 3 It depicts an explanatory diagram illustrating an example of character string set identification information set in each input box.

FIG. 4 It depicts an explanatory diagram illustrating a configuration example of an input method execution unit of the first exemplary embodiment.

FIG. 5 It depicts an explanatory diagram illustrating an example of displaying different recommended character strings.

FIG. 6 It depicts an explanatory diagram illustrating a configuration example of a second exemplary embodiment of the input support system according to the present invention.

FIG. 7 It depicts a block diagram illustrating a configuration example of a dictionary determiner.

FIG. 8 It depicts an explanatory diagram illustrating an example of a method of deciding a dictionary from an input place.

FIG. 9 It depicts an explanatory diagram illustrating an example of information stored in the candidate character string storage unit.

FIG. 10 It depicts an explanatory diagram illustrating an example of an input history.

FIG. 11 It depicts an explanatory diagram illustrating an example of a dictionary estimation result.

FIG. 12 It depicts an explanatory diagram illustrating a configuration example of a third exemplary embodiment of the input support system according to the present invention.

FIG. 13 It depicts an explanatory diagram illustrating a configuration example of a fourth exemplary embodiment of the input support system according to the present invention.

FIG. 14 It depicts an explanatory diagram illustrating an example of an operation of displaying recommended character strings by using additional recommended character strings.

FIG. 15 It depicts an explanatory diagram illustrating an example of a variation of the fourth exemplary embodiment.

FIG. 16 It depicts a block diagram illustrating an outline of the input support system according to the present invention.

### DESCRIPTION OF EMBODIMENTS

Exemplary embodiments of the present invention will be described below with reference to the accompanying drawings.

### Exemplary Embodiment 1

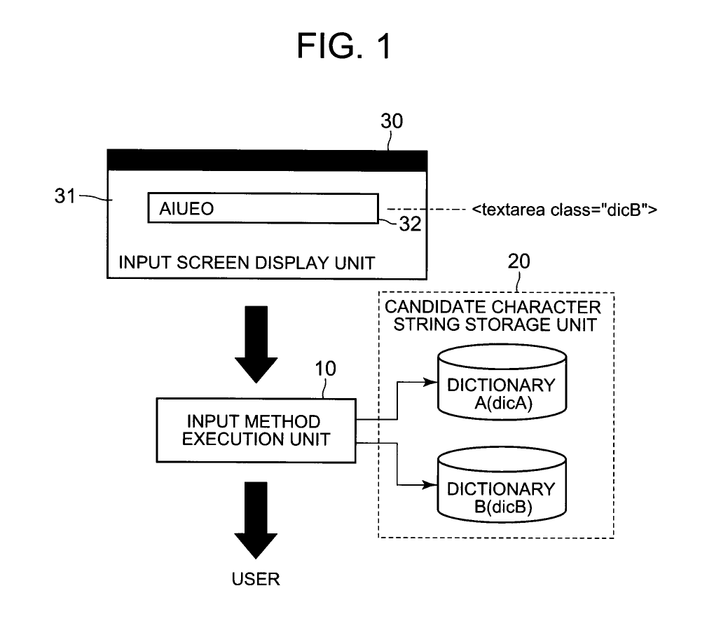

FIG. 1 is an explanatory diagram illustrating a configuration example of a first exemplary embodiment of an input support system according to the present invention. The input support system of this exemplary embodiment includes an input method execution unit 10, a candidate character string storage unit 20, and an input screen display unit 30.

The candidate character string storage unit 20 stores a plurality of candidate character strings recommended for an input character string. In this exemplary embodiment, the term “character string” means a combination of one or more characters. The plurality of candidate character strings stored in the candidate character string storage unit 20 are classified into one or more sets. Hereinafter, a set of candidate character strings will be referred to as “dictionary” in some cases. In addition, one candidate character string may belong to a plurality of sets.

Moreover, a set of candidate character strings is specified by information by which each set is identifiable (hereinafter, the information is referred to as “character string set identification information”). The example illustrated in FIG. 1 depicts that sets of candidate character strings are explicitly represented by two dictionaries (dictionary A, dictionary B) and the respective dictionaries are specified by character string set identification information dicA and dicB, respectively.

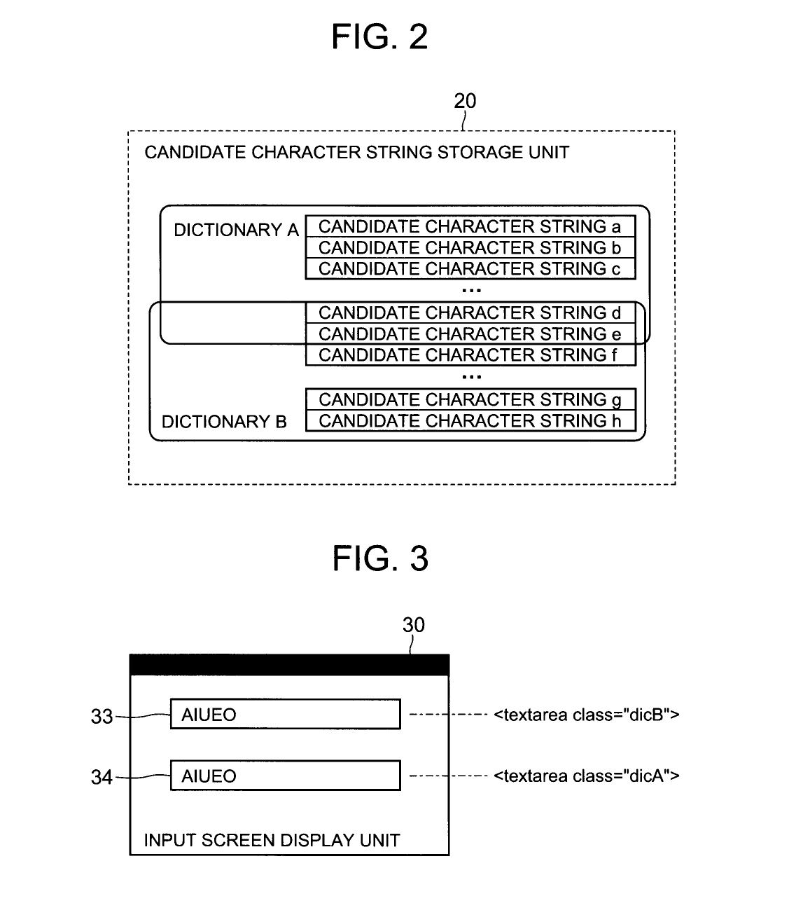

In the example illustrated in FIG. 1, two sets (dictionaries) of candidate character strings are illustrated. The number of sets of candidate character strings, however, is not limited to two, but three or more sets of candidate character strings may be used. Moreover, the respective dictionaries may include the same candidate character string. FIG. 2 is an explanatory diagram illustrating an example of sets of candidate character strings stored in the candidate character string storage unit 20. In the example depicted in FIG. 2, candidate character strings d and e belong to two dictionaries A and B.

The sets of candidate character strings specified by the character string set identification information are previously determined. For example, in the example illustrated in FIG. 2, the sets of candidate character strings are previously determined to be specified as candidate character strings a to e by the character string set identification information which represents the dictionary A.

Moreover, the candidate character string storage unit 20 may include not only candidate character strings, but also other information necessary to extract candidate character strings. Specifically, a dictionary used in the present invention may include general information for use in a kana-kanji conversion or a predictive conversion in the Japanese language. The candidate character string storage unit 20 is implemented by, for example, a magnetic disk or the like.

The input screen display unit 30 displays an input screen for accepting an input by a user. The input screen display unit 30 displays an input page including one or more input boxes as an input screen on a display device or the like and, upon accepting the input by the user via an input device (not illustrated) such as a keyboard or a touch panel, displays the input content in each input box. The input page is, for example, a web page, an input application having an exclusive input form, or the like.

Furthermore, when a recommended character string is decided for the character string input to the input box, the input screen display unit 30 displays the recommended character string in association with the input box. The input screen display unit 30 may display the recommended character string, for example, in a position adjacent to the input box. Moreover, if there are a plurality of recommended character strings, the input screen display unit 30 may display the recommended character strings in a list format in the position adjacent to the input box. The method of displaying the recommended character strings is arbitrary and is not limited to these methods.

Furthermore, in this exemplary embodiment, the input screen display unit 30 displays an input screen where character string set identification information is preset, for each input box or for each input page including one or more input boxes. Specifically, the character string set identification information is determined according to the input place of the character string. The term “input place” means not only an input box to which characters are input, but also a part or the whole of the input page including one or more input boxes. Moreover, if one input box is able to specify a plurality of areas, the term “input place” also means the areas.

For example, if the input page is a web site, a creator of the web site previously embeds character string set identification information, which specifies a dictionary to be used for the input box, in association with the input box on the input page or with the input page by using an html tag. For example, when the creator of the web site wants to use the dictionary B for an input box 32 in an input page 31 illustrated in FIG. 1, the creator of the web site may previously embed an html tag such as <textarea class=“dicB”> on the input page 31. Consequently, the input screen display unit 30 is able to display an input screen where the character string set identification information is preset.

Moreover, pieces of character string set identification information different from each other may be set in the respective input boxes on the same input page. FIG. 3 is an explanatory diagram illustrating an example of character string set identification information set for each input box. The example illustrated in FIG. 3 depicts that setting is made for using the dictionary B when a character string is input to an input box 33 while setting is made for using the dictionary A when a character string is input to an input box 34.

Furthermore, when detecting that a character string is input to the input box, the input screen display unit 30 notifies the input method execution unit 10 of the character string set identification information for at least one of the input box and the input page. A method of detecting the input of the character string is arbitrary. The input screen display unit 30 may detect an input of a character string, for example, every time characters are input or may detect an input of a character string when an explicit specification (for example, depression of a predetermined button or the like) is made by a user.

When the character string set identification information is set only for one of the input box and the input page, the input screen display unit 30 notifies the input method execution unit 10 of the already-set character string set identification information. Furthermore, when the character string set identification information is set for both of the input box and the input page, the input screen display unit 30 may notify the input method execution unit 10 of the character string set identification information of both or may notify the input method execution unit 10 of the character string set identification information for any one of the input box and the input page on the basis of a preset priority or the like.

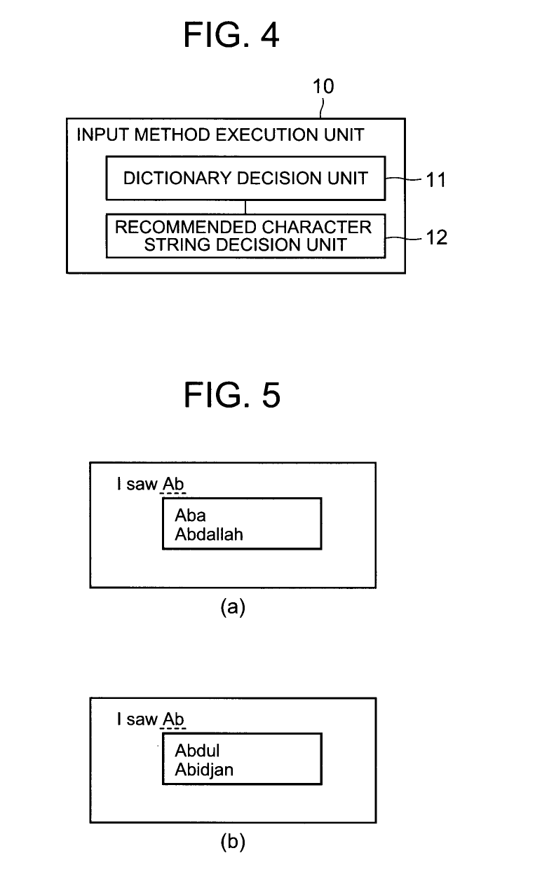

FIG. 4 is an explanatory diagram illustrating a configuration example of the input method execution unit 10 of this exemplary embodiment. The input method execution unit 10 of this exemplary embodiment includes a dictionary decision unit 11 and a recommended character string decision unit 12.

The dictionary decision unit 11 decides a set of candidate character strings (namely, a dictionary) out of the candidate character strings stored in the candidate character string storage unit 20. Specifically, the dictionary decision unit 11 decides the set of candidate character strings on the basis of character string set identification information determined according to the input place of the character string. In the exemplary embodiment, the dictionary decision unit 11 decides the set of candidate character strings on the basis of the character string set identification information notified by the input screen display unit 30.

The recommended character string decision unit 12 decides recommended character strings for the input character string by using the decided set of candidate character strings. The number of recommended character strings may be one or two or more. In addition, the number of characters included in the input character string may be one or two or more.

Moreover, the recommended character string decision unit 12 decides the recommended character strings by using a generally-known kana-kanji conversion or predictive conversion technique in the Japanese language. Specifically, after the decision of the set of candidate character strings, the recommended character string decision unit 12 may decide the recommended character strings for the input characters in the general conversion method by using the decided set of candidate character strings.

For example, if “Ab” is input as an input character string, the recommended character string decision unit 12 may extract all words beginning with “Ab” in reading (for example, “Aba” and “Abdallah”) from the set of candidate character strings to decide the extracted words as recommended character strings.

The input method execution unit 10 (more specifically, the dictionary decision unit 11 and the recommended character string decision unit 12) and the input screen display unit 30 are implemented by the CPU of a computer that operates according to a program (input support program). For example, the program may be stored in a storage unit (not illustrated) of a device in the input support system, so that the CPU reads the program and operates as the input method execution unit 10 (more specifically, the dictionary decision unit 11 and the recommended character string decision unit 12) and the input screen display unit 30 according to the program. Furthermore, each of the input method execution unit 10 and the input screen display unit 30 may be implemented by dedicated hardware.

As described hereinabove, according to the exemplary embodiment, the dictionary decision unit 11 decides the set of candidate character strings on the basis of the character string set identification information determined according to the input place of the character string out of the candidate character strings stored in the candidate character string storage unit 20. The recommended character string decision unit 12, then, decides the recommended character strings for the input character string by using the decided set of candidate character strings. Therefore, appropriate input candidates are able to be recommended according to the input place without performing a complicated operation.

In the case of inputting a character string to weblogs different in category from each other by using the input support system of this exemplary embodiment, different candidate character strings are able to be recommended even if the same character string is input to the weblogs.

FIG. 5 is an explanatory diagram illustrating an example of displaying different recommended character strings when the same character string is input. In the example illustrated in FIG. 5, it is assumed that FIG. 5(a) depicts a text box in a weblog related to politics (hereinafter, referred to as “politics blog”) and that FIG. 5(b) depicts a text box in a weblog related to entertainment (hereinafter, referred to as “entertainment blog”). Here, in the case where the same character string “Ab” is input, the names of politicians are able to be displayed as recommended character strings in the politics blog, while the names of entertainers are able to be displayed as recommended character strings in the entertainment blog.

Specifically, as illustrated in FIG. 5, a recommendation result varies according to a site, unlike a general input method, in this exemplary embodiment, thereby enabling a reduction in the user's conversion cost.

Moreover, in a general search site, it is necessary to collect a large amount of information that has been input to the search site in the past. Meanwhile, in the exemplary embodiment, appropriate character strings are able to be recommended only by designating information indicative of a dictionary for an input page with a tag (for example, an html tag). The dictionary for use in this recommendation only needs to be prepared by the input method, thereby saving the labor of a site creator.

### Exemplary Embodiment 2

The following describes a second exemplary embodiment of the input support system according to the present invention. In the first exemplary embodiment, the input method execution unit 10 directly receives the character string set identification information from the input screen display unit 30 and decides the set of candidate character strings. In other words, the input support system of the first exemplary embodiment sets the character string set identification information according to the input place and decides the recommended character strings by using the character string set identification information.

Meanwhile, the input support system of this exemplary embodiment decides the recommended character strings by using information indicative of the input place into which a character string is input (hereinafter, the information is referred to as “input place specifying information”), instead of using the character string set identification information. The method will be described in detail below.

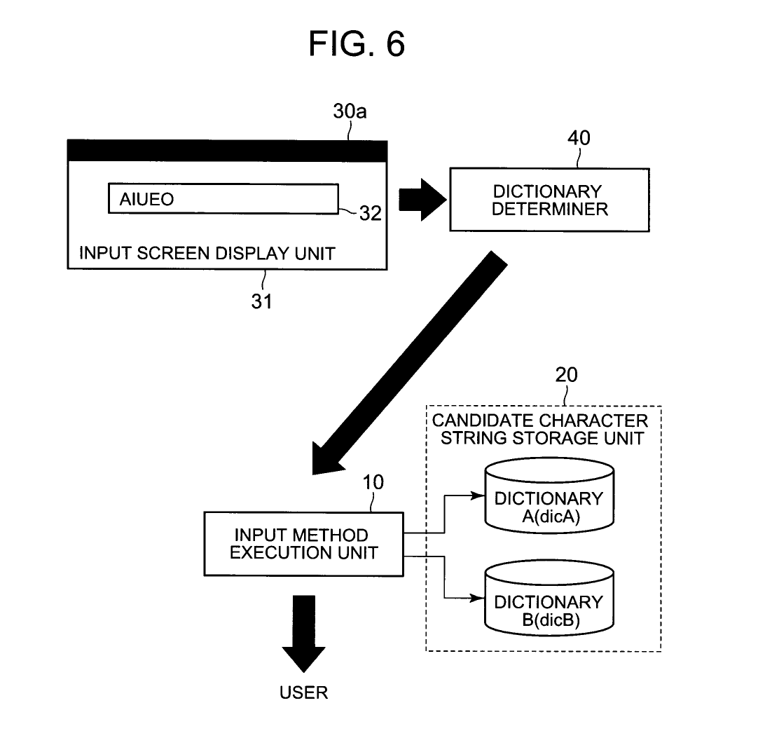

FIG. 6 is an explanatory diagram illustrating a configuration example of a second exemplary embodiment of the input support system according to the present invention. The same reference numerals as those of FIG. 1 are used for the same components as those of the first exemplary embodiment to omit the explanation. The input support system of this exemplary embodiment includes an input method execution unit 10, a candidate character string storage unit 20, an input screen display unit 30a, and a dictionary determiner 40. The contents of the input method execution unit 10 and the candidate character string storage unit 20 of this exemplary embodiment are the same as those of the first exemplary embodiment.

The input screen display unit 30a displays an input screen for accepting an input by a user and displays the decided recommended character strings in association with the input box. Upon an input of a character string, the input screen display unit 30a of this exemplary embodiment notifies the dictionary determiner 40 of the input place specifying information indicative of the place into which the character string is input along with the character string. Specifically, this exemplary embodiment differs from the first exemplary embodiment in that the input screen display unit 30a outputs the input place specifying information, instead of the character string set identification information.

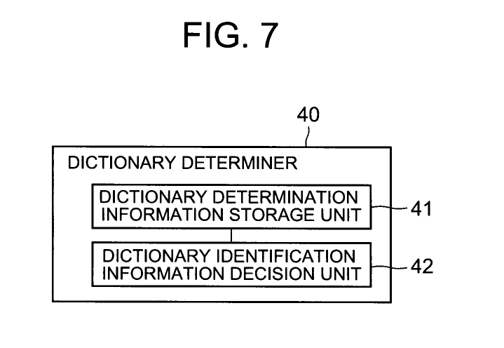

The dictionary determiner 40 decides a dictionary appropriate for the input place of the character string. FIG. 7 is a block diagram illustrating a configuration example of the dictionary determiner 40. The dictionary determiner 40 of this exemplary embodiment includes a dictionary determination information storage unit 41 and a dictionary identification information decision unit 42.

The dictionary determination information storage unit 41 stores information necessary for the dictionary identification information decision unit 42 to decide a dictionary. Thereafter, the dictionary identification information decision unit 42 decides a dictionary from the information stored in the dictionary determination information storage unit 41 on the basis of the input place specifying information notified by the input screen display unit 30a. Concretely, the dictionary identification information decision unit 42 specifies which is the set of character strings likely to be input into the input place.

In other words, the dictionary identification information decision unit 42 decides the character string set identification information for specifying a set of candidate character strings more likely to be input into an input place from the input place of the character string on the basis of the information stored in the dictionary determination information storage unit 41. For example, if the dictionary determination information storage unit 41 stores a past input history for each input place, the dictionary identification information decision unit 42 may decide a dictionary that includes the largest number of words included in the text having been input so far as an appropriate dictionary.

The following describes an example of a method in which the dictionary identification information decision unit 42 decides the character string set identification information. The method, however, of deciding the character string set identification information from the input place of the character string on the basis of the information stored in the dictionary determination information storage unit 41 is not limited to the method described below.

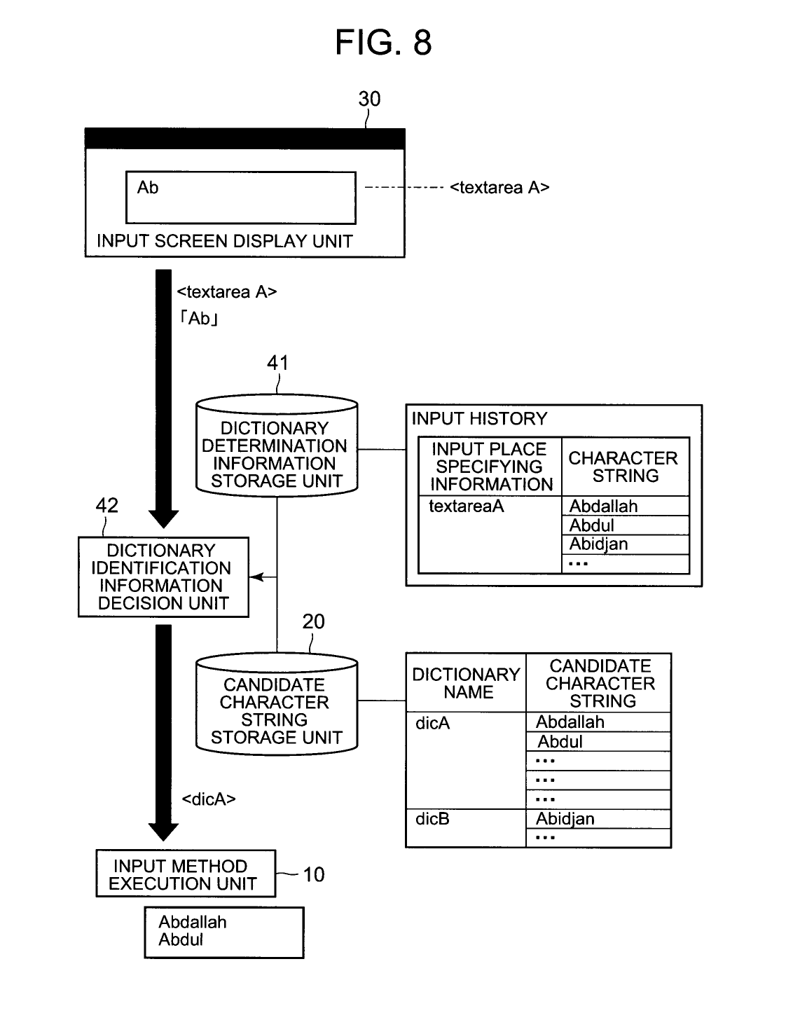

FIG. 8 is an explanatory diagram illustrating an example of the method of deciding a dictionary from an input place. In the example illustrated in FIG. 8, it is assumed that the dictionary determination information storage unit 41 stores an input history where input places (input place specifying information) are associated with input character strings.

Here, a user is assumed to have input a character string “Ab” in the input place specified by <textareaA>. In the example illustrated in FIG. 8, the dictionary dicA includes two words, “Abdallah” and “Abdul,” and the dictionary dicB includes one word, “Abidjan,” out of “Abdallah,” “Abdul,” and “Abidjan” input in <textareaA> in the past. Therefore, the dictionary identification information decision unit 42 decides the dictionary dicA that includes the largest number of words included in the text having been input in <textareaA> so far as an appropriate dictionary and notifies the input method execution unit 10.

The input method execution unit 10 decides a set of candidate character strings on the basis of the decided character string set identification information and then decides recommended character strings for the input character string by using the decided set of candidate character strings. In the example illustrated in FIG. 8, the input method execution unit 10 recommends two words “Abdallah” and “Abdul” as input candidate character strings including “Ab” as the head characters out of the candidate character strings included in the dictionary dicA. Also by this method, appropriate input candidates can be recommended according to the input place.

Although the dictionary determination information storage unit 41 stores an input history for each input box in the example illustrated in FIG. 8, the dictionary determination information storage unit 41 may store an input history for each site. In this case, for example, URL (uniform resource locator) may be used as the input place specifying information for identifying the site.

The following describes another example of the method in which the dictionary identification information decision unit 42 decides the character string set identification information. In this example, the dictionary determination information storage unit 41 stores information having been input to the target input box in the past as an input log (input history. Furthermore, the candidate character string storage unit 20 stores candidate character strings for each dictionary and the dictionary identification information decision unit 42 estimates which is the dictionary to be used in each input box on the basis of the matching degree between the input log and the candidate character strings in each dictionary.

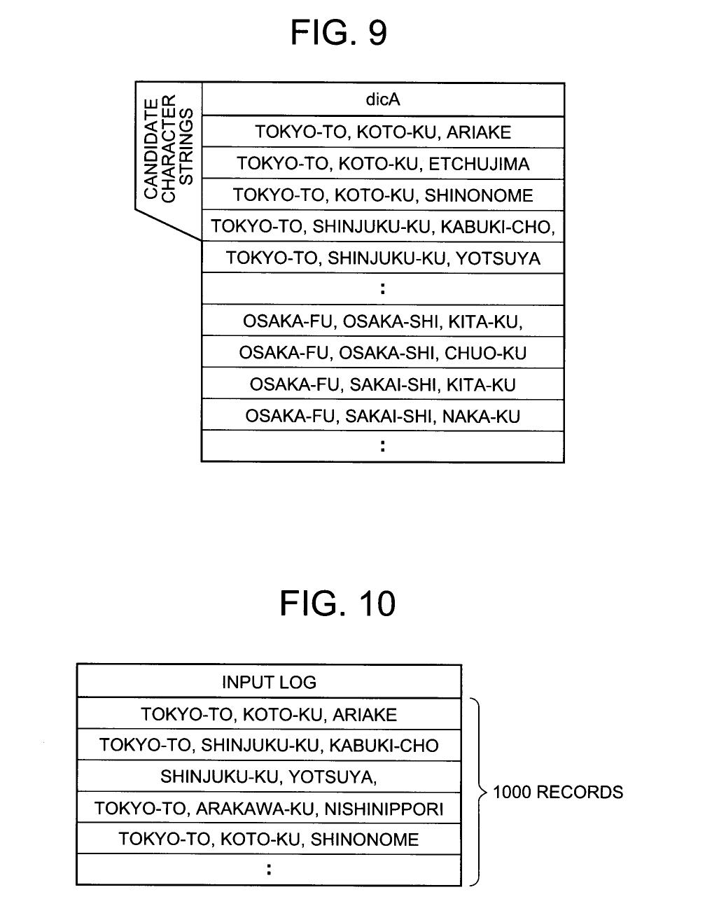

FIG. 9 is an explanatory diagram illustrating an example of information stored in the candidate character string storage unit. FIG. 9 depicts an example of candidate character strings of “address” specified by character string set identification information “dicA.” In this specification, it is assumed that the candidate character string storage unit 20 stores only dictionary identified by “dicA.”

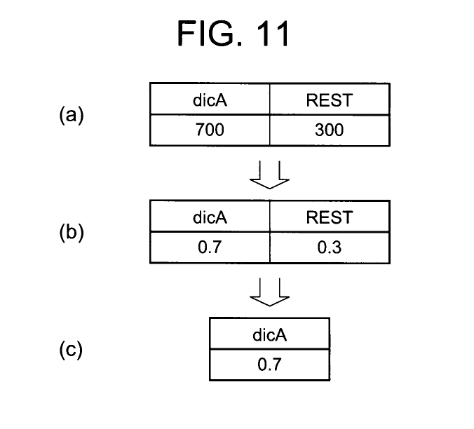

FIG. 10 is an explanatory diagram illustrating an example of an input history stored in the dictionary determination information storage unit 41. Moreover, FIG. 11 is an explanatory diagram illustrating an example of a dictionary estimation result. In addition, the example illustrated in FIG. 11 is achieved by estimating the dictionary on the basis of the example of the candidate character string storage unit 20 illustrated in FIG. 9 and the example of the dictionary determination information storage unit 41 illustrated in FIG. 10.

The dictionary identification information decision unit 42 may compare the input log with the candidate character strings in each dictionary to find the number of matched input log records for each dictionary so as to calculate a matching degree based thereon. Specifically, the dictionary identification information decision unit 42 specifies which dictionary includes the candidate character string to which the content of the input log corresponds. Furthermore, the dictionary identification information decision unit 42 may count the number of corresponding matches for each dictionary to calculate a matching degree based on the result.

For example, if the input log record and the candidate character string exactly match each other, the dictionary identification information decision unit 42 may determine that the input log record corresponds to the candidate character string in each dictionary. Furthermore, if the beginning of the input log record matches that of the candidate character string as forward matching or if the ratio of the number of characters matched in the case of forward matching is a predetermined value or more, the dictionary identification information decision unit 42 may determine that the input log record corresponds to the candidate character string in each dictionary.

In addition, if the degree of similarity between the input log record and the candidate character string is a predetermined value or more, the dictionary identification information decision unit 42 may determine that the input log record corresponds to the candidate character string in each dictionary. Incidentally, the dictionary identification information decision unit 42 may use an edit distance, information distance vectorized using an n-gram, or the like for the degree of similarity. Further, the dictionary identification information decision unit 42 may use a weighted distance to change the degree of importance depending on the character position such as to give weight to matching between first character strings for the degree of similarity.

Furthermore, if determining that the input log records correspond to the candidate character strings in a plurality of dictionaries, the dictionary identification information decision unit 42 may count the number of matches with respect to each dictionary. Moreover, if the determination is made based on the forward matching, the dictionary identification information decision unit 42 may count the number of matches with respect to a dictionary including a candidate character string with a larger ratio of the number of characters in the candidate character string having matched the input log record or may count the number of matches only with respect to a dictionary including a candidate character string with a shorter distance indicative of the similarity with the character string.

As a result of comparison between the example of the candidate character string storage unit 20 illustrated in FIG. 9 and the example of the dictionary determination information storage unit 41 illustrated in FIG. 10, it is depicted in FIG. 11(a) that the number of input log records that match candidate character strings in “dicA” is 700 and the number of other input log records “rest” (i.e., the number of input log records that do not match candidate character strings in any dictionary) is 300. The dictionary identification information decision unit 42 may use the number of matches as the matching degree of each dictionary.

Moreover, the dictionary identification information decision unit 42 may use the number of input log records that do not match candidate character strings in any dictionary as an index to determine whether the types of the dictionaries in use are unknown. Moreover, the dictionary identification information decision unit 42 may calculate a matching ratio relative to the total number of input log records based on the number of matches to set it as the matching degree. In other words, the dictionary identification information decision unit 42 may set, as the matching degree, a value obtained by dividing the number of input log records matching the candidate character strings in each dictionary by the total number of input log records used for the determination. FIG. 11(b) illustrates an example of calculation results of matching degrees.

Based on the matching degree of each dictionary calculated as mentioned above, the dictionary identification information decision unit 42 estimates the dictionary which is used in the input box where the input log records are collected. In the example, as depicted in FIG. 11(b), the matching degree for “dicA” is 0.7 and the matching degree for the “rest” is 0.3. Therefore, as the estimation result, the dictionary identification information decision unit 42 may decide the “dicA” as a dictionary to be used in the input box (See FIG. 11(c)). Also by using the aforementioned method, the dictionary identification information decision unit 42 is able to decide the character string set identification information for specifying a set of candidate character strings more likely to be input into the input place.

The input method execution unit 10, the input screen display unit 30, and the dictionary determiner 40 (more specifically, the dictionary identification information decision unit 42) are implemented by the CPU of a computer operating according to a program (input support program). Furthermore, each of the input method execution unit 10, the input screen display unit 30, and the dictionary determiner 40 (more specifically, the dictionary identification information decision unit 42) may be implemented by dedicated hardware.

Moreover, the dictionary determination information storage unit 41 is implemented by, for example, a magnetic disk or the like. Although this exemplary embodiment depicts that the dictionary determiner 40 includes the dictionary determination information storage unit 41 and the dictionary identification information decision unit 42, the dictionary determination information storage unit 41 and the dictionary identification information decision unit 42 may be implemented by devices different from each other.

As described hereinabove, according to the exemplary embodiment, the dictionary determiner 40 (more specifically, the dictionary identification information decision unit 42) decides the character string set identification information (for example, dicA or the like) for specifying a set of candidate character strings more likely to be input into the input place of the character string therefrom on the basis of information (for example, an input history) necessary for deciding the dictionary stored in the dictionary determination information storage unit 41. Then, the input method execution unit 10 (more specifically, the dictionary decision unit 11) decides the set of candidate character strings on the basis of the decided character string set identification information.

Therefore, in this exemplary embodiment, it is unnecessary to explicitly describe which dictionary is used on the site side on the input page, thereby enabling a reduction in production cost to a person who creates the input page in addition to the effect of the first exemplary embodiment.

### Exemplary Embodiment 3

The following describes a third exemplary embodiment of the input support system according to the present invention. In the second exemplary embodiment, there has been described a method in which the dictionary determiner 40 decides a dictionary on the basis of an input history where the input place specifying information is associated with character strings. This exemplary embodiment differs from the second exemplary embodiment in that the contents input in each input place are stored and a dictionary is decided by using the stored contents.

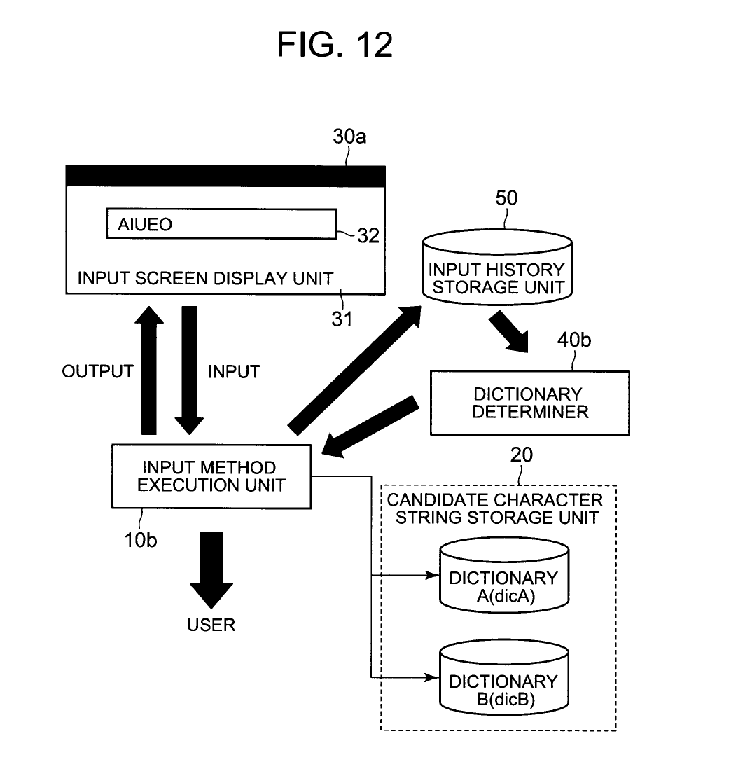

FIG. 12 is an explanatory diagram illustrating a configuration example of the third exemplary embodiment of the input support system according to the present invention. The same reference numerals as those of FIG. 6 are used for the same components as those of the second exemplary embodiment to omit the explanation. The input support system of this exemplary embodiment includes an input method execution unit 10b, a candidate character string storage unit 20, an input screen display unit 30a, a dictionary determiner 40b, and an input history storage unit 50. The contents of the candidate character string storage unit 20 and the input screen display unit 30a of this exemplary embodiment are the same as those of the second exemplary embodiment.

The input history storage unit 50 stores the input place specifying information and the character strings in association with each other. The contents stored in the input history storage unit 50 may be the same as those of the dictionary determination information storage unit 41 illustrated in the second exemplary embodiment or may be different therefrom. In other words, the dictionary determiner 40b may include the input history storage unit 50. The input history storage unit 50 is implemented by, for example, a magnetic disk or the like.

Upon input of a character string to an input box by a user, the input method execution unit 10b stores an input history into the input history storage unit 50, the input history containing the input place specifying information indicative of the input box associated with the input character string. Other processes are the same as those of the input method execution unit 10b of the first exemplary embodiment.

For example, when one character string is selected out of recommended character strings, the input method execution unit 10b may store the selected character string and the input place specifying information in association with each other in the input history storage unit 50. The timing for storing the input history is arbitrary.

Thereafter, upon notification of the input place specifying information from the input screen display unit 30a, the dictionary determiner 40b decides a dictionary from the input history stored in the input history storage unit 50 on the basis of the notified input place specifying information. The dictionary determiner 40b may decide a dictionary by using, for example, the same method as for the dictionary identification information decision unit 42 in the second exemplary embodiment.

According to this exemplary embodiment, the input method execution unit 10b registers the input history, in which the input character string is associated with the input place specifying information indicative of the input place into which the character string is input, in the input history storage unit 50. In this case, appropriate character strings are able to be recommended only by transmitting the input place specifying information along with the character string from the input screen (for example, the site) to the input method execution unit 10b. In other words, an effect of eliminating the work on the site side is achieved.

### Exemplary Embodiment 4

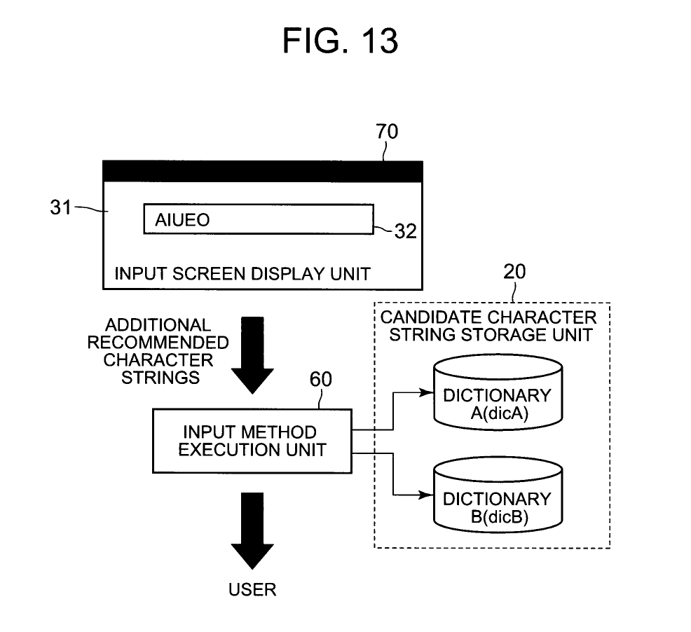

FIG. 13 is an explanatory diagram illustrating a configuration example of a fourth exemplary embodiment of the input support system according to the present invention. The same reference numerals as those of FIG. 1 are used for the same components as those of the first exemplary embodiment to omit the explanation. The input support system of this exemplary embodiment includes an input method execution unit 60, a candidate character string storage unit 20, and an input screen display unit 70.

The input screen display unit 70 of this exemplary embodiment notifies the input method execution unit 60 of a set of character strings to be recommended or information by which the set of character strings is specifiable according to the input place of the character string in addition to the function of the input screen display unit 30 in the first exemplary embodiment. Hereinafter, the set of character strings to be recommended or the information by which the set of character strings is specifiable will be referred to as additional recommended character strings.

The input screen display unit 70 may notify the input method execution unit 60 of the set of character strings as additional recommended character strings. The input screen display unit 70 may transmit character strings such as, for example, “Abraham” and “Abigayle” as additional recommended character strings to the input method execution unit 60.

In addition, the input screen display unit 70 may notify the input method execution unit 60 of information indicative of the position where the set of character strings is stored (for example, URL or the like) as additional recommended character strings. This enables a reduction in the amount of data transmitted to the input method execution unit 60.

The input method execution unit 60 decides recommended character strings for the input character string by using the dictionary stored in the candidate character string storage unit 20 and the additional recommended character strings notified by the input screen display unit 70, in addition to the function of the input method execution unit 10 in the first exemplary embodiment.

More specifically, the input method execution unit 60 decides the set of candidate character strings (dictionary) on the basis of the character string set identification information determined according to the input place of the character string and then adds notified additional recommended character strings to the set of candidate character strings. For example, in the case of receiving the set of character strings as additional recommended character strings, the input method execution unit 60 may add the set of character strings to the set of candidate character strings. Further, for example, in the case of receiving information indicative of the position where the set of character strings is stored as additional recommended character strings, the input method execution unit 60 may specify the set of character strings on the basis of the information indicative of the position to add the specified set of character strings to the set of candidate character strings.

A method of subsequently deciding the recommended character strings for the input character string by using the decided set of candidate character strings is the same as the method in which the recommended character string decision unit 12 recommends the character strings as illustrated in the first exemplary embodiment.

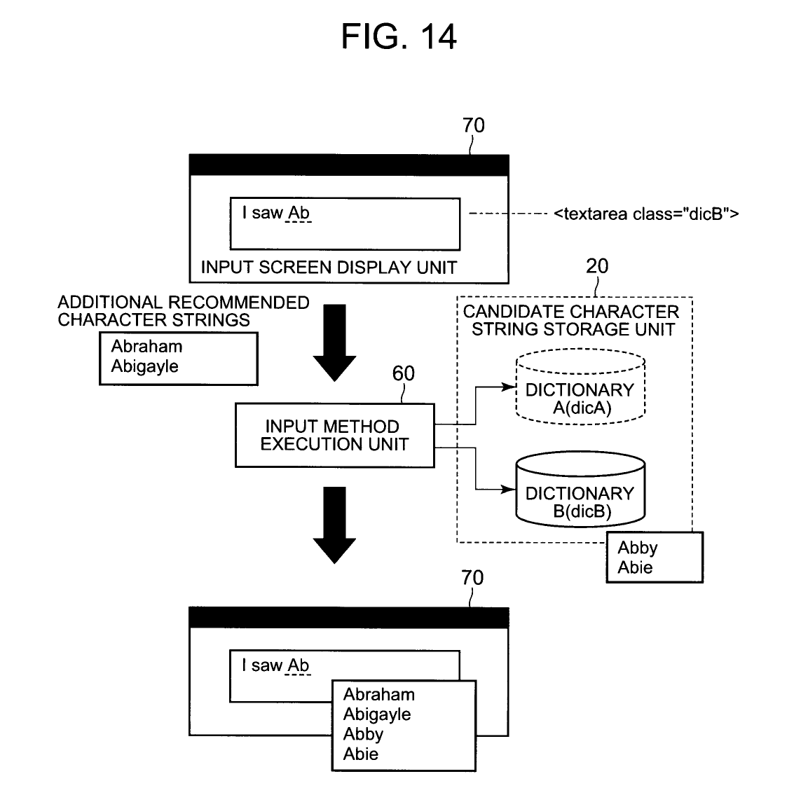

FIG. 14 is an explanatory diagram illustrating an example of an operation of displaying recommended character strings by using additional recommended character strings. In the example illustrated in FIG. 14, “Abraham” and “Abigayle” are transmitted as additional recommended character strings to the input method execution unit 60. Moreover, the dictionary dicB is selected on the basis of the input place specifying information and “Abby” and “Abie” are registered in the dictionary dicB. If “Ab” is input to the input box in this state, “Abraham” and “Abigayle” transmitted from the input screen display unit 70 and “Abby” and “Abie” contained in the selected dictionary dicB are gathered and displayed as recommended character strings.

In this case, the recommended character strings may include also character strings that seem to be likely to be input on the site side, thereby enabling recommendation of more appropriate character strings for a user.

As described hereinabove, in this exemplary embodiment, the input method execution unit 60 adds additional recommended character strings to the set of candidate character strings decided on the basis of the character string set identification information. Specifically, the input screen display unit 70 transmits the additional character strings to be recommended on the site and the additional recommended character strings representing the positions where the character strings are stored to the input method execution unit 60, so that the input method execution unit 60 adds the additional recommended character strings to the decided dictionary. Therefore, the character strings recommended on the site side are also able to be added to the recommended character strings in addition to the effects of the first exemplary embodiment, thereby enabling recommendation of more appropriate character strings.

In the description of this exemplary embodiment, the input method execution unit 60 decides the set of candidate character strings (dictionary) on the basis of the character string set identification information transmitted from the input screen display unit 70 in the same manner as the input method execution unit 10 in the first exemplary embodiment. In addition, the dictionary determiner may decide the dictionary by using the input place specifying information in the same manner as in the second or third exemplary embodiment.

Moreover, in the fourth exemplary embodiment, the input method execution unit 60 decides the set of candidate character strings (namely, dictionary) out of the candidate character strings stored in the candidate character string storage unit 20. The input method execution unit 60, however, may recommend character strings for all candidate character strings stored in the candidate character string storage unit 20.

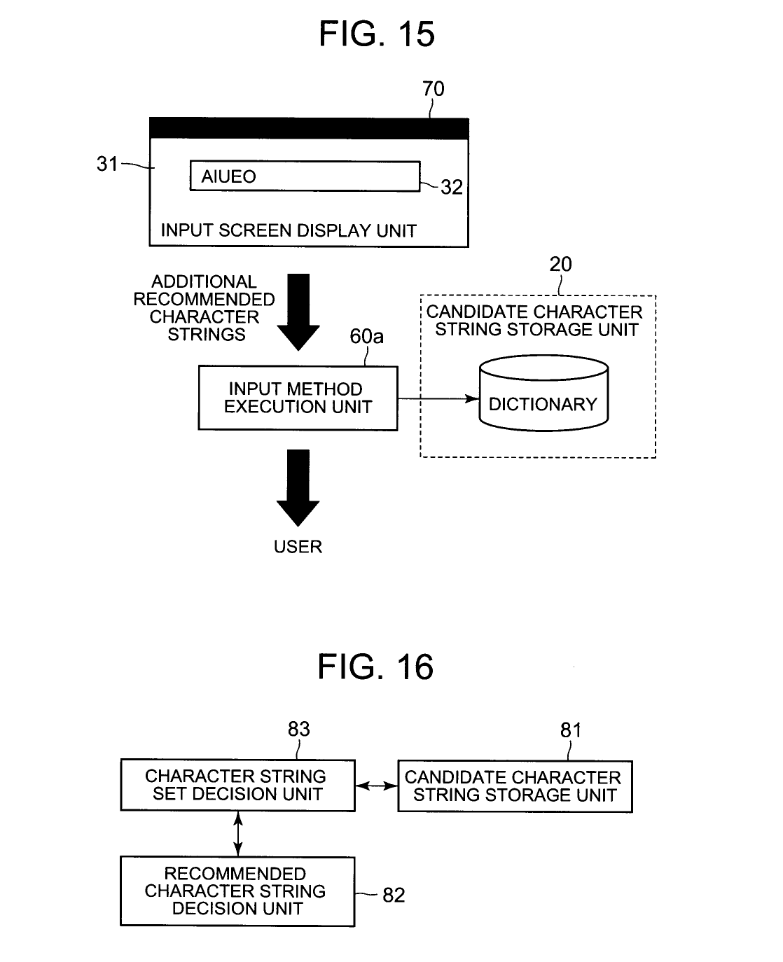

FIG. 15 is an explanatory diagram illustrating an example of a variation of the fourth exemplary embodiment. As illustrated in FIG. 15, the input method execution unit 60a may decide recommended character strings for the input character string by using the additional recommended character strings received from the input screen display unit 70 and the candidate character strings stored in the candidate character string storage unit 20. It is more preferable to decide the set of candidate character strings according to the input place of the character string since it enables the target for the recommended character strings to be narrowed down.

The following describes the outline of the present invention. FIG. 16 is a block diagram illustrating an outline of the input support system according to the present invention. The input support system according to the present invention includes a candidate character string storage unit 81 (for example, the candidate character string storage unit 20) which stores candidate character strings recommended for an input character string, a recommended character string decision unit 82 (for example, the recommended character string decision unit 12) which decides recommended character strings for the input character string, and a character string set decision unit 83 (for example, the dictionary decision unit 11) which decides a set of candidate character strings out of the candidate character strings stored in the candidate character string storage unit 81 on the basis of the character string set identification information (for example, the dictionary dicA or the like) by which a set of candidate character strings (for example, a dictionary) is identifiable.

The character string set decision unit 83 decides the set of candidate character strings on the basis of the character string set identification information determined according to the input place (for example, an input box, a web site, an input screen, or the like) of the character string. The recommended character string decision unit 82 decides the recommended character strings for the input character string by using the decided set of candidate character strings.

According to the aforementioned configuration, appropriate input candidates are able to be recommended according to the input place without performing a complicated operation.

Further, the input support system may include a dictionary determination information storage unit (for example, the dictionary determination information storage unit 41) which stores dictionary determination information (for example, an input history) in which input place specifying information is associated with the character string, where the input place specifying information is information by which the input place (for example, an input box, an input page, or the like) of the character string is specifiable, and an identification information decision unit (for example, the dictionary identification information decision unit 42) which decides character string set identification information for specifying a set of candidate character strings more likely to be input into the input place of the character string therefrom on the basis of the dictionary determination information. Moreover, the character string set decision unit 83 may decide the set of candidate character strings on the basis of the decided character string set identification information.

According to the above configuration, it is unnecessary to explicitly describe which dictionary is used on the site side on the input page, thereby enabling a reduction in production cost to a person who creates the input page.

Furthermore, the input support system may include an input history registration unit which registers an input history in the dictionary determination information storage unit, where the input character string is associated with the input place specifying information indicative of the input place into which the character string is input in the input history. According to the configuration, an effect of eliminating a work on the site side is achieved.

Furthermore, the input support system may include an input screen display unit (for example, the input screen display unit 30) which displays an input screen in which the character string set identification information is previously determined for each input box or for each input page including one or more input boxes and a specifying information notification unit (for example, the input screen display unit 30) which notifies the character string set decision unit of the character string set identification information of at least one of the input box and the input page including the input box when detecting an input of a character string to the input box (for example, when the character is input or when a predetermined button is depressed).

The screen for explicitly designating a dictionary required to be used is created for each input place and the dictionary name is notified at the timing when the character string is input in this manner, by which appropriate input candidates are able to be recommended according to the input place without performing a complicated operation.

Furthermore, the character string set decision unit 83 may add a set of character strings to be recommended according to the input place of the character string or information by which the set of character strings is specifiable (for example, the additional recommended character strings) to the set of candidate character strings decided on the basis of the character string set identification information. According to the configuration, the recommended character strings may include also character strings that seem to be likely to be input on the site side, thereby enabling recommendation of more appropriate character strings for the user.

Moreover, the input screen display unit may display recommended character strings, which have been decided for the character string input to the input box, in association with the input box (for example, listing or the like).

Although the present invention has been described with reference to the exemplary embodiments and examples hereinabove, the present invention is not limited thereto. A variety of changes, which can be understood by those skilled in the art, may be made in the configuration and details of the present invention within the scope thereof.

This application claims priority to Japanese Patent Application No. 2013-009573 filed on Jan. 22, 2013, and the entire disclosure thereof is hereby incorporated herein by reference.

### INDUSTRIAL APPLICABILITY

The present invention is preferably applied to the input support system for supporting input to an input box by a user.

### REFERENCE SIGNS LIST

10, 10b, 60, 60a Input method execution unit
11 Dictionary decision unit
12 Recommended character string decision unit
20 Candidate character string storage unit
30, 30a, 70 Input screen display unit
31 Input page
32 Input box
40, 40b Dictionary determiner
41 Dictionary determination information storage unit
42 Dictionary identification information decision unit
50 Input history storage unit

What is claimed is:

1. An input support system comprising:
a candidate character string storage unit which stores candidate character strings recommended for an input character string;
a recommended character string decision unit which decides the recommended character strings for the input character string; and
a character string set decision unit which decides a set of candidate character strings out of the candidate character strings stored in the candidate character string storage unit based on character string set identification information which is information by which the set of candidate character strings is identifiable,
wherein:
the character string set decision unit decides the set of candidate character strings based on the character string set identification information determined according to an input place of the character string; and
the recommended character string decision unit decides the recommended character strings for the input character string by using the decided set of candidate character strings.

2. The input support system according to claim 1, further comprising:
a dictionary determination information storage unit which stores dictionary determination information in which input place specifying information is associated with the character string, where the input place specifying information is information by which the input place of the character string is specifiable; and
an identification information decision unit which decides character string set identification information for specifying a set of candidate character strings more likely to be input into the input place of the character string based on the dictionary determination information,
wherein the character string set decision unit decides the set of candidate character strings based on the decided character string set identification information.

3. The input support system according to claim 2, further comprising an input history registration unit which registers an input history in the dictionary determination information storage unit, where the input history includes the input character string associated with the input place specifying information indicative of the input place into which the character string is input.

4. The input support system according to claim 1, further comprising:
an input screen display unit which displays an input screen in which the character string set identification information is previously determined for each input box or for each input page including one or more of the input boxes; and
a specifying information notification unit which notifies the character string set decision unit of the character string set identification information of at least one of the input box and the input page including the input box when detecting an input of a character string to the input box.

5. The input support system according to claim 1 wherein the character string set decision unit adds a set of character strings to be recommended according to the input place of the character string or information by which the set of character strings is specifiable to the decided set of candidate character strings based on the character string set identification information.

6. The input support system according to claim 1 wherein the input screen display unit displays the recommended character strings decided for the character string input to the input box so as to be associated with the input box.

7. An input support method comprising:
deciding a set of candidate character strings out of candidate character strings stored in a candidate character string storage unit which stores candidate character strings based on character string set identification information which is information by which a set of candidate character strings recommended for an input character string is identifiable; and
deciding the recommended character strings for the input character string by using the decided set of candidate character strings,
wherein the set of candidate character strings is decided based on the character string set identification information determined according to an input place of the character string.

8. The input support method according to claim 7, further comprising:
deciding character string set identification information for specifying a set of candidate character strings more likely to be input into the input place of the character string based on the dictionary determination information in which input place specifying information is associated with the character string, where the input place specifying information is information by which the input place of the character string is specifiable; and
deciding the set of candidate character strings based on the decided character string set identification information.

9. A non-transitory computer readable information recording medium storing an input support program, when executed by a processor, that performs a method for:
deciding a set of candidate character strings out of candidate character strings stored in a candidate character string storage unit which stores candidate character strings based on character string set identification information which is information by which a set of candidate character strings recommended for an input character string is identifiable; and
deciding the recommended character strings for the input character string by using the decided set of candidate character strings,
wherein the set of candidate character strings is decided based on the character string set identification information determined according to an input place of the character string.

10. The non-transitory computer readable information recording medium according to claim 9, further comprising: deciding character string set identification information for specifying a set of candidate character strings more likely to be input into the input place of the character string based on the dictionary determination information in which input place specifying information is associated with the character string, where the input place specifying information is information by which the input place of the character string is specifiable; and
deciding the set of candidate character strings based on the decided character string set identification information.
